(19) United States
(12) Patent Application Publication
(10) Pub. No.: US 2013/0120193 A1
(43) Pub. Date: May 16, 2013

(54) GLASS CERAMICS FOR USE AS A DIELECTRIC FOR GIGAHERTZ APPLICATIONS

(71) Applicants: Bernd Hoppe, Ingelheim (DE); Michael Kluge, Offenbach A. M. (DE); Stephan Knoener, Herford (DE); Martin Letz, Mainz (DE); Bernd Ruedinger, Woerrstadt (DE); Daniela Seiler, Alzey (DE)

(72) Inventors: Bernd Hoppe, Ingelheim (DE); Michael Kluge, Offenbach A. M. (DE); Stephan Knoener, Herford (DE); Martin Letz, Mainz (DE); Bernd Ruedinger, Woerrstadt (DE); Daniela Seiler, Alzey (DE)

(73) Assignee: SCHOTT AG, Mainz (DE)

(21) Appl. No.: 13/297,441

(22) Filed: Nov. 16, 2011

(51) Int. Cl. C03C 10/00; H01Q 9/04

(52) U.S. Cl. CPC C03C 10/0036; H01Q 9/0407
USPC 343/700 MS; 501/32; 65/33.7

(57) ABSTRACT

A glass-ceramic which is particularly suitable as dielectric for use in the high-frequency range, in particular as dielectric resonator, as electronic frequency filter element or as antenna element is disclosed. The glass-ceramic has at least the following constituents (in mol % on an oxide basis): 5-50% of SiO₂, 0-20% of Al₂O₃, 0-25% of B₂O₃, 0-25% of BaO, 10-60% of TiO₂, 5-35% of Re₂O₃, where Ba can be partly replaced by Sr, Ca, Mg, where Re is a lanthanide or yttrium and where Ti can be partly replaced by Zr, Hf, Y, Nb, V, Ta.

### BACKGROUND OF THE INVENTION

The invention relates to a glass-ceramic which can be used as dielectric in the high-frequency range (frequency>200 MHz), in particular in the gigahertz range (frequency f>1 GHz).

Special materials which have a very high relative permittivity ∈ combined with a very low dielectric loss (tan δ) are required for a number of applications in the high-frequency range. To avoid close-range detuning due to the body of a user (referred to as “body loading”), dielectric charging of antennae, filters and other devices is of particular importance. This requires dielectrics which have a high relative permittivity, with ∈>15, and a low dielectric loss (tan δ) of not more than 10⁻², preferably lower, in the high-frequency range. Furthermore, the temperature dependence of the resonance frequency τ_{f} should be very small. Finally, such a material should be able to be processed in a very simple and inexpensive way in order to make near net shapes possible at low cost.

A number of ceramic materials which are processed by sintering processes are known in the prior art. These include a BiNbO₄ system which has been disclosed in Mirsaneh et al., “Circularly Loaded Dielectric-Loaded Antennas: Current Technology and Future Challenges”, Adv. Funct. Materials 18, (2008), pp. 1-8, for use in the case of dielectrically charged antennae for the gigahertz range. This material is used for producing the two most widely used forms of antennae, the circularly polarized DLA helix antenna (D-LQH antenna) and the square patch antenna. For this purpose, a glass having the composition 30 mol % of Bi₂O₃, 30 mol % of Nb₂O₅, 30 mol % of B₂O₃ and 10 mol % of SiO₂ is melted in a conventional way at 1250° C. for two hours.

This glass was poured into cylindrical moulds, depressurized at from 500 to 520° C. and slowly cooled to room temperature. Crystallization was subsequently carried out at various temperatures in the range from 600° C. to 1000° C. The optimal value for antennae applications is said to be, for a heat treatment at 960° C., a relative permittivity ∈ of 15 with a quality factor Q·f₀ of 15 000 GHz and a temperature coefficient of the resonance frequency τᵣ of −80 MK⁻¹. The crystalline phase determined here was essentially orthorhombic BiNbO₄.

This system using bismuth and niobium is very expensive in terms of the raw materials.

In addition, there are a number of sintered ceramic materials (cf. U.S. Pat. No. 6,184,845 B1, US 2007/063902 A1). In these references, a sintered ceramic material based on zirconium titanate or based on zirconium-tin titanate having a relative permittivity of about 36 is disclosed as dielectric material for the ceramic core of a dielectrically charged D-LQH antenna. The material is said to be produced by extrusion or pressing and subsequent sintering.

Further sintered materials are indicated in the review by M. T. Sebastian et al., “Low loss dielectric materials for LTCC applications”, International Materials Reviews, Vol. 53, 2008, pp. 57-90. Even though some of these materials are referred to as “glass-ceramics”, they are sintered materials since they are produced by sintering a mixture of vitreous and crystalline powders.

Dielectrics produced by sintering have a number of disadvantages: every sintering process is always accompanied by a certain shrinkage, which leads to geometric inaccuracies and corresponding final machining. Furthermore, every sintering process results in a certain residual porosity which is a disadvantage when the surface is metalized. The metal penetrates into the pores and increases the dielectric loss of the dielectric.

In addition, the production of sintered materials is fundamentally relatively complicated and expensive.

### SUMMARY OF THE INVENTION

A first object of the invention is to provide an improved material which can be used as dielectric for high-frequency applications.

A second object of the invention is to provide an improved material which has a high relative permittivity.

A third object of the invention is to provide an improved material which has a low dielectric loss.

A fourth object of the invention is to provide an improved material for a dielectric, which should be able to be produced and processed in a very simple and inexpensive way.

A fifth object of the invention is to provide an improved antenna element which can be used in particular in a dielectrically charged antenna which can be reduced using a body loading.

According to the invention, these and other objects are achieved by a glass-ceramic which has at least the following constituents (in mol % on an oxide basis):

| | |
|---|---|
| SiO₂ | 5-50 |
| Al₂O₃ | 0-20 |
| B₂O₃ | 0-25 |
| BaO | 0-25 |
| TiO₂ | 10-60 |
| RE₂O₃ | 5-35, |

where Ba can be partly, preferably to an extent of up to 10%, replaced by Sr, Ca, Mg, where RE is lanthanum, another lanthanide or yttrium, and Ti can be partly, preferably to an extent of up to 10%, replaced by Zr, Hf, Y, Nb, V, Ta.

The object of the invention is solved completely in this way.

It has been found that homogeneous glasses which can subsequently be converted by a ceramicizing treatment into a homogeneous glass-ceramic which has a high relative permittivity, a low dielectric loss and a low temperature dependence of the resonance frequency can be melted using such a glass composition. The material can be produced as glass ceramic in a simple and inexpensive way and allows near net shaping by melt-technological processes, in particular by casting or optionally by pressing.

For the purposes of the present patent application, the term “glass-ceramic” refers to a material which, starting from a homogeneous glass produced by melting, is converted by means of a specific heat treatment into a partially crystalline body in which a large number of crystallites are distributed essentially homogeneously in a vitreous residual phase.

In an advantageous embodiment of the invention, the glass-ceramic has the following constituents (in mol % on an oxide basis):

| | |
|---|---|
| SiO₂ | 10-40 |
| Al₂O₃ | 0-10 |
| B₂O₃ | 5-25 |
| BaO | 0-20 |
| TiO₂ | 15-50 |
| Re₂O₃ | 10-30, |

where Ba can be partly, preferably to an extent of up to 10%, replaced by Sr, Ca, Mg, where Re is a lanthanide or yttrium, and Ti can be partly, preferably to an extent of up to 10%, replaced by Zr, Hf, Y, Nb, V, Ta.

Furthermore, the glass-ceramic can contain refining agents in customary amounts, preferably from 0.01 to 3 mol % of a refining agent which is preferably selected from the group consisting of Sb₂O₃ and As₂O₃.

The glass-ceramic of the invention preferably has a dielectric loss (tan δ) of not more than 10⁻², preferably not more than 10⁻³, in high-frequency applications (f>200 MHz).

Furthermore, the glass-ceramic preferably has a relative permittivity ∈ of at least 15, preferably >18, preferably in the range from 20 to 80.

The glass-ceramic of the invention also preferably has a temperature dependence of the resonance frequency τ_{f} of not more than 200 ppm/K, preferably not more than 50 ppm/K, particularly preferably not more than 10 ppm/K.

In a further advantageous embodiment of the invention, the glass-ceramic of the invention has at least one mixed crystal phase based on RE, Ti, Si, O and optionally Ba, where Ba can be at least partly, replaced by Sr, Ca, Mg, where RE is a lanthanide or yttrium, and Ti can be at least partly replaced by Zr, Hf, Y, Nb, V, Ta.

In particular, the glass-ceramic of the invention can contain at least one mixed crystal phase selected from the group consisting of Ba, RE, TiO, RE₂Ti₂O₇, RE₂Ti₂SiO₉ and RE₄Ti₉O₂₄, where RE is lanthanum, another lanthanide or yttrium, up to 10% of Ba can be replaced by Sr, Ca, Mg, and up to 10% of Ti can be replaced by Zr, Hf, Y, Nb, V, Ta.

The glass-ceramic of the invention can preferably have a proportion of crystalline material of at least 30% by volume, preferably up to 95% by volume.

The average crystallite size is preferably from 10 nm to 50 μm and is preferably in the range from 100 nm to 1 μm.

The glass-ceramic of the invention is particularly suitable as dielectric for a dielectric resonator, an electronic frequency filter element or an antenna element in the high-frequency range (f>200 MHz).

Use as dielectric for a cylindrical antenna element or a patch antenna element is particularly useful.

A dielectric according to the invention having a dielectric loss of not more than 10⁻² in the high-frequency range can be produced by means of the following steps:

melting and homogenization of a starting glass containing the constituents (in mol % on an oxide basis):

| | |
|---|---|
| SiO₂ | 5-50 |
| Al₂O₃ | 0-20 |
| B₂O₃ | 0-25 |
| BaO | 0-25 |
| TiO₂ | 10-60 |
| RE₂O₃ | 5-35, |

where Ba can be partly, preferably to an extent of up to 10%, replaced by Sr, Ca, Mg, where RE is a lanthanide or yttrium, and Ti can be partly, preferably to an extent of up to 10%, replaced by Zr, Hf, Y, Nb, V, Ta;

pouring of the starting glass into a desired mould;

cooling of the starting glass to room temperature;

ceramicization of the starting glass by means of a heat treatment.

In a preferred embodiment of the invention, the starting glass comprises at least the following constituents (in mol % on an oxide basis):

| | |
|---|---|
| SiO₂ | 10-40 |
| Al₂O₃ | 0-10 |
| B₂O₃ | 5-25 |
| BaO | 0-20 |
| TiO₂ | 15-50 |
| RE₂O₃ | 10-30, |

where Ba can be partly, preferably to an extent of up to 10%, replaced by Sr, Ca, Mg, where RE is a lanthanide or yttrium, and Ti can be partly, preferably to an extent of up to 10%, replaced by Zr, Hf, Y, Nb, V, Ta.

The starting glass is preferably brought to near net shape by means of a hot forming process, in particular by casting, tube drawing, rod drawing or extrusion.

Further features and advantages of the invention can be derived from the following description of preferred examples with reference to the drawing.

### BRIEF DESCRIPTION OF THE DRAWING

FIG. 1, the only FIGURE, shows the result of an X-ray diffraction analysis.

### DESCRIPTION OF PREFERRED EMBODIMENTS

### Examples

Table 1 shows various glass compositions for a starting glass in the system Ba—La—Ti—Si—O.

The various glass samples of Examples 1 to 9 are firstly melted and homogenized in the usual way using conventional starting materials, with platinum crucibles, PT/RI crucibles, PT/RH crucibles, fused silica crucibles or aluminium oxide crucibles being able to be used. The samples are firstly melted at 1350° C. for 2 hours, then refined at 1400° C. for 30 minutes, stirred and homogenized by means of a platinum stirrer for 20 minutes, allowed to stand for 10 minutes and then poured into suitable moulds made of, for instance, steel, graphite, aluminium oxide or fused silica and then brought to near net shape.

After cooling to room temperature, the glass is subjected to a ceramicization step, which can be carried out, for example, by means of an infrared heating process or by means of a conventional process.

A typical ceramicization cycle by means of an infrared furnace is as follows:

heating at 300° C./min to 1050° C.;

hold at 1050° C. for 7 seconds;

heating to 1200° C. at a heating rate of 50 K/min;

hold at 1200° C. for 15 minutes;

cooling to about 500° C. at a cooling rate of about 50 K/min by switching off the furnace;

removal of the specimen from the furnace when a temperature of about 500° C. has been reached.

A ceramicization cycle in a conventional furnace is carried out by heat treatment at 925° C. for 15 hours.

If necessary, the mouldings can, after casting, be subjected to a file grinding or polishing treatment or in the case of the production of cylindrical mouldings, can be machined by centreless grinding of the cylindrical surface.

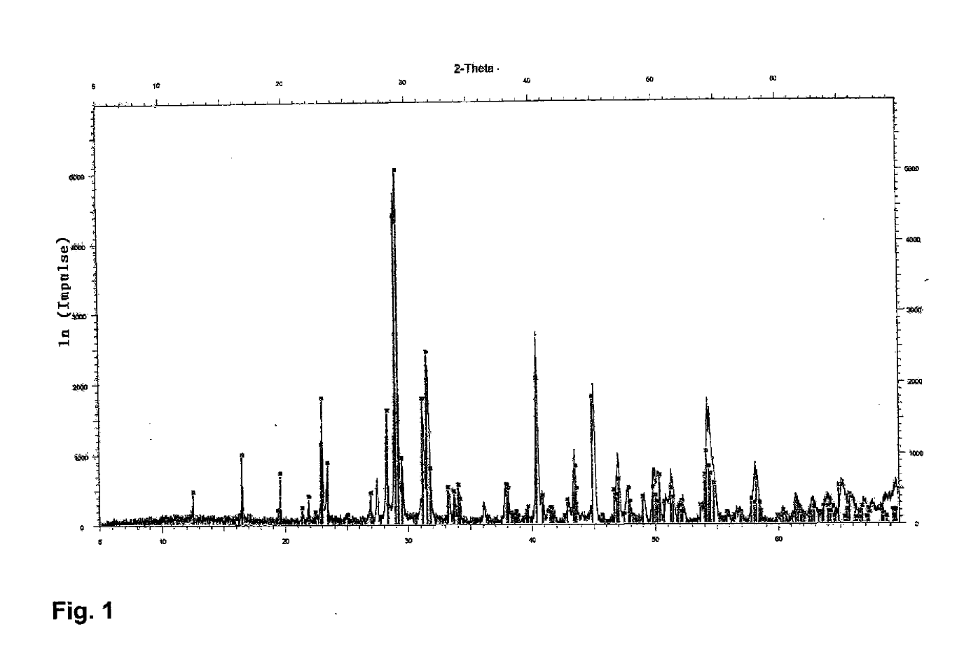

FIG. 1 shows an X-ray diffraction analysis of sample 9 after ceramicization. The clearly predominant crystal phase is La₂Ti₂SiO₉. In addition, small proportions of rutile TiO₂ were found.

The proportion by volume of the crystalline phase in this sample is in the order of from about 50 to 70% by volume.

Relative permittivities ∈ were measured on samples 1 to 9; these were all greater than 15 and in the range from 20 to 50,

The samples also display a low dielectric loss and a high quality.

The quality Q is the reciprocal of the dielectric loss (tan δ):

Q=1/tan(δ)

The quality is measured by the Hakki-Coleman resonance method. The quality factor is determined here as the product of quality Q and measurement frequency f₀.

All samples 1 to 9 had a quality factor Q·f₀ in the range from 2000 to 3000 GHz. In the case of sample 1, a relative permittivity ∈ of 22.4 and a quality Q of 205 were measured at 10.09 GHz, i.e. a quality factor of 2068 was measured.

The temperature coefficient Σ_{f} of the resonance frequency is very low for all measured samples and is in the range −40 ppm/K<τ_{f}<40 ppm/K.

In uses as dielectric for antennae which are suitable, in particular, for mobile GPS antennae for mobile phones, the frequency range is above 200 MHz, in particular in the range from about 800 MHz to 70 GHz. The dielectric charging of the antenna reduces the sensitivity of the antenna to detuning by the user.

TABLE 1

| | Sample number | | | | | | | | |
|---|---|---|---|---|---|---|---|---|---|
| | 1 | 2 | 3 | 4 | 5 | 6 | 7 | 8 | 9 |
| | Content | Content | Content | Content | Content | Content | Content | Content | Content |
| Component | in mol % | in mol % | in mol % | in mol % | in mol % | in mol % | in mol % | in mol % | in mol % |
| SiO₂ | 21.00 | 23.00 | 27.00 | 19.00 | 23.00 | 19.00 | 27.00 | 21.00 | 21.00 |
| Al₂O₃ | 6.00 | 4.00 | 2.00 | 2.00 | 2.00 | 4.00 | 2.00 | 4.00 | 6.00 |
| B₂O₃ | 12.60 | 10.50 | 10.50 | 14.50 | 12.50 | 12.50 | 10.50 | 10.50 | 12.60 |
| BaO | 0.00 | 14.75 | 14.25 | 15.25 | 14.75 | 15.25 | 14.25 | 15.25 | 0.00 |
| TiO₂ | 40.20 | 34.90 | 33.90 | 35.90 | 34.90 | 35.90 | 33.90 | 35.90 | 40.20 |
| Sb₂O₃ | 0.10 | 0.10 | 0.10 | 0.10 | 0.10 | 0.10 | 0.10 | 0.10 | 0.10 |
| La₂O₃ | 20.10 | 12.75 | 12.25 | 13.25 | 12.75 | 13.25 | 12.25 | 13.25 | 20.10 |
| Total | 100.00 | 100.00 | 100.00 | 100.00 | 100.00 | 100.00 | 100.00 | 100.00 | 100.00 |

What is claimed is:

1. A glass-ceramic which has at least the following constituents (in mol % on an oxide basis):

| | |
|---|---|
| SiO₂ | 5-50 |
| Al₂O₃ | 0-20 |
| B₂O₃ | 0-25 |
| BaO | 0-25 |
| TiO₂ | 10-60 |
| RE₂O₃ | 5-35, |

where Ba can be partly replaced by at least one element selected from the group consisting of Sr, Ca and Mg;
where RE is selected from the group consisting of at least one lanthanide and yttrium; and
where Ti can be partly replaced by at least one element selected from the group consisting of Zr, Hf, Y, Nb, V and Ta.

2. The glass-ceramic according to claim 1 which has the following constituents (in mol % on an oxide basis):

| | |
|---|---|
| SiO₂ | 10-40 |
| Al₂O₃ | 0-10 |
| B₂O₃ | 5-25 |
| BaO | 0-20 |
| TiO₂ | 15-50 |
| RE₂O₃ | 10-30, |

where Ba can be partly replaced by at least one element selected from the group consisting of Sr, Ca and Mg;
where RE is selected from the group consisting of at least one lanthanide and yttrium; and
where Ti can be partly replaced by at least one element selected from the group consisting of Zr, Hf, Y, Nb, V and Ta.

3. The glass-ceramic according to claim 1, in which up to 10% of the barium is replaced.

4. The glass-ceramic according to claim 1, in which up to 10% of the titanium is replaced.

5. The glass-ceramic according to claim 1, which additionally contains from 0.01 to 3 mol % of at least one refining agent.

6. The glass-ceramic according to claim 5, in which the at least one refining agent is selected from the group consisting of Sb₂O₃ and As₂O₃.

7. The glass-ceramic according to claim 1, which has a dielectric loss (tan δ) of not more than 10⁻² in the high-frequency range (frequency f>200 MHz).

8. The glass-ceramic according to claim 1, having a relative permittivity ∈ of at least 15.

9. The glass-ceramic according to claim 1, wherein the absolute value of the temperature dependence of the resonance frequency |τ_{f}| is not more than 200 ppm/IC.

10. The glass-ceramic according to claim 1, wherein the absolute value of the temperature dependence of the resonance frequency |τ_{f}| is not more than 10 ppm/K.

11. The glass-ceramic according to claim 1, which contains at least one mixed crystal phase based on RE, Ti, Si, O, Ba, where Ba can be at least partly replaced by Sr, Ca, Mg, where RE is a lanthanide or yttrium and where Ti can be at least partly replaced by Zr, Hf, Y, Nb, V, Ta.

12. The glass-ceramic according to claim 1, which contains at least one mixed crystal phase selected from the group consisting of BaRETiO, RE₂Ti₂O₇, RE₂Ti₂SiO₉ and RE₄Ti₉O₂₄, where RE lanthanum, another lanthanide or yttrium, where up to 10% of Ba can be replaced by Sr, Ca, Mg and where up to 10% of Ti can be replaced by Zr, Hf, Y, Nb, V, Ta.

13. The glass-ceramic according to claim 1, which has a proportion of crystalline material of at least 30% by volume.

14. The glass-ceramic according to claim 13, which has a proportion of crystalline material of up to 95% by volume.

15. The glass-ceramic according to claim 1, having an average crystallite size of from 10 nanometres to 50 microns.

16. An antenna element for the high-frequency range which has a glass-ceramic according to claim 1 which is partly metallized on the outer surface thereof.

17. The antenna element according to claim 16, which is formed as an antenna selected from the group consisting of a cylindrical antenna element and a patch antenna element.

18. A method of producing a dielectric having a dielectric loss of not more than 10⁻² in the high-frequency range, comprising the following steps:
melting and homogenizing a starting glass containing the constituents (in mol % on an oxide basis):

| | |
|---|---|
| SiO₂ | 5-50 |
| Al₂O₃ | 0-20 |
| B₂O₃ | 0-25 |
| BaO | 0-25 |
| TiO₂ | 10-60 |
| RE₂O₃ | 5-35, |

where Ba can be partly replaced by at least one element selected from the group consisting of Sr, Ca and Mg;
where RE is selected from the group consisting of at least one lanthanide and yttrium; and
where Ti can be partly replaced by at least one element selected from the group consisting of Zr, Hf, Y, Nb, V and Ta;
pouring the starting glass into a desired mould;
cooling the starting glass to room temperature;
ceramizing the starting glass by means of a heat treatment.

19. The method of claim 18, in which the starting glass has at least the following constituents (in mol % on an oxide basis):

| | |
|---|---|
| SiO₂ | 10-40 |
| Al₂O₃ | 0-10 |
| B₂O₃ | 5-25 |
| BaO | 0-20 |
| TiO₂ | 15-50 |
| RE₂O₃ | 10-30, |

where Ba can be partly replaced by at least one element selected from the group consisting of Sr, Ca and Mg;
where RE is selected from the group consisting of at least one lanthanide and yttrium; and
where Ti can be partly replaced by at least one element selected from the group consisting of Zr, Hf, Y, Nb, V and Ta.

20. The method of claim 19, in which the starting glass is brought to near net shape by means of a melt-technological process.
